(19) United States
(12) Patent Application Publication
(10) Pub. No.: US 2010/0179938 A1
(43) Pub. Date: Jul. 15, 2010

(54) SYSTEM AND METHOD FOR AUTOMATICALLY OPENING FILES ACCORDING TO PREDETERMIND CONDITIONS

(75) Inventors: YI-FANG WU, Tu-Cheng (TW); YONG-HUI XIAO, Shenzhen City (CN); QING-HUA LIU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO.,LTD., Shenzhen City (CN); HON HAI PRECISION INDUSTRY CO., LTD., Tu-Cheng (TW)

(21) Appl. No.: 12/556,583

(22) Filed: Sep. 10, 2009

(30) Foreign Application Priority Data
Jan. 13, 2009 (CN) 200910300149.0

(51) Int. Cl. G06N 5/02

(52) U.S. Cl. 706/54; 700/94

(57) ABSTRACT

A method for automatically opening a file associated with a predetermined condition is provided. The file is matched with the predetermined condition. Information related to the predetermined condition, such as temperature, light intensity, and sound intensity is detected. The detected information is sent to a processing module. The processing module monitors the detected information to determine whether the predetermined condition is satisfied and sends an instruction to an executing module to open the file when the predetermined condition is satisfied. A system for automatically opening the file associated with the predetermined condition is also disclosed.

### BACKGROUND

1. Technical Field

The present disclosure relates to a system and a method for the automatic opening of files.

2. Description of Related Art

A typical portable device, such as a digital photo frame (DPF), a MP3/MP4/MP5 player, or a cell phone, is capable of storing many different files such as photos, audio files, and video files. A user of portable device can view photos or listen to songs as he/she likes utilizing the portable device. However, a typical method to select and open the files stored in the portable device requires a user to operate buttons/keys of the portable device. The portable device cannot automatically open the files according to predetermined conditions, such as at specified times. Manually operating buttons/keys to open files may be an inconvenience in certain circumstances.

Therefore, a system and a method for automatically selecting and opening files according to predetermined conditions is desired.

### BRIEF DESCRIPTION OF THE DRAWINGS

FIG. 1 is a block diagram of a first embodiment of a system for automatically opening files according to predetermined conditions;

FIG. 2 is a block diagram of a second embodiment of a system for automatically opening files according to predetermined conditions in accordance with the present disclosure;

FIG. 3 is a flow chart of a first embodiment of a method for automatically opening files according to predetermined conditions in accordance with the present disclosure; and

FIG. 4 is a flow chart of a second embodiment of a method for automatically opening files according to predetermined conditions in accordance with the present disclosure.

### DETAILED DESCRIPTION

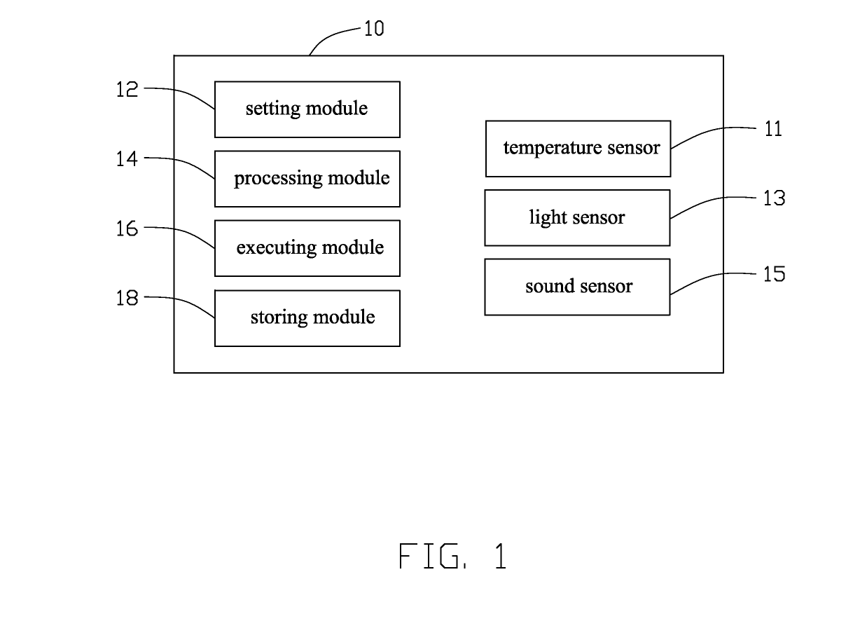

Referring to FIG. 1, a first embodiment of a system for automatically opening files according to predetermined conditions, includes a first portable device 10, such as a digital photo frame (DPF), a MP3/MP4/MP5 player, or a cell phone. The first portable device 10 includes a setting module 12, a processing module 14, an executing module 16, and a storing module 18 for storing different files, such as photos, video files and/or audio files. The first portable device 10 further includes a temperature sensor 11, a light sensor 13, and a sound sensor 15 installed therein.

The setting module 12 is utilized for associating the files with predetermined conditions. For example, a slow and gentle song is associated with a predetermined condition of low ambient light intensity and low ambient sound level. Ambient temperature can be detected by the temperature sensor 11; ambient light intensity can be detected by the light sensor 13, and ambient sound level can be detected by the sound sensor 15. The processing module 14 is utilized to monitor whether any of the predetermined conditions is satisfied. If one of the predetermined conditions is satisfied, the processing module 14 sends an instruction to the executing module 16 for automatically opening the related file. For example, the executing module 16 automatically opens a file of the slow and gentle song and plays the song when the ambient light intensity and the ambient sound level are both low, such as during the evening or in the night.

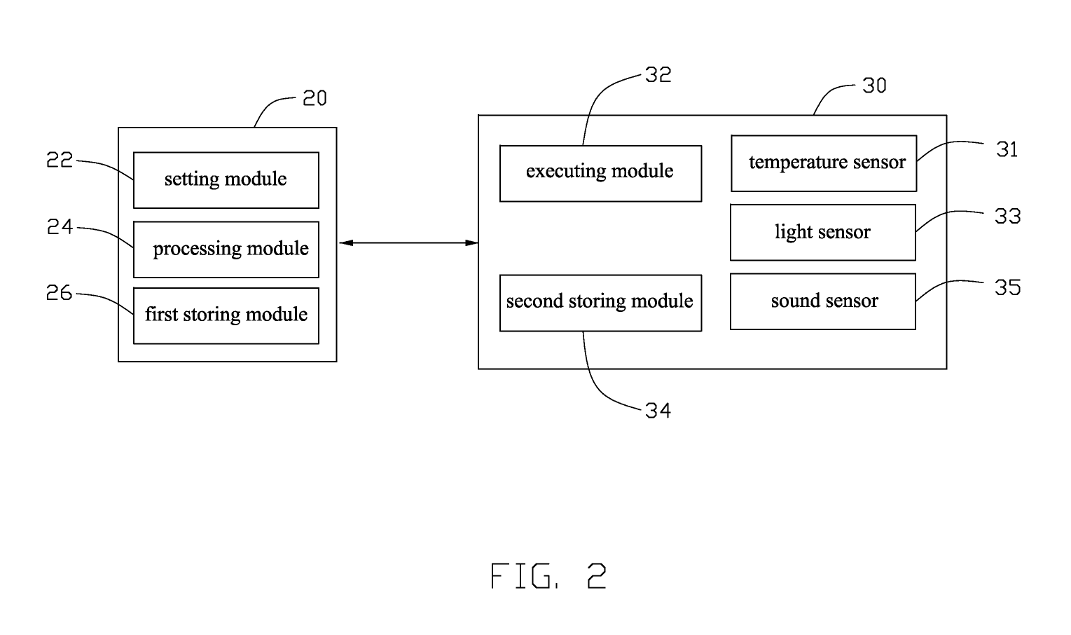

Referring to FIG. 2, a second embodiment of a system for automatically opening files associated with predetermined conditions includes a control device 20, such as a computer, and a second portable device 30. The control device 20 connects to the second portable device 30 via a network cable or a wireless link, such as a wireless fidelity (WIFI) link. The control device 20 includes a setting module 22, a processing module 24, and a first storing module 26 capable of storing different files, such as photos, video files and/or audio files. The second portable device 30 includes an executing module 32, a second storing module 34 capable of storing the files, a temperature sensor 31, a light sensor 33, and a sound sensor 35.

The second portable device 30 sends ambient temperature, light intensity, and sound level data to the control device 20 via the network cable or the wireless link. The temperature, light intensity, and sound level are detected by the temperature sensor 31, the light sensor 33, and the sound sensor 35 respectively. The setting module 22 of the control device 20 is utilized to associate the files with predetermined conditions. The processing module 24 is utilized to monitor whether one of the predetermined conditions is satisfied and sends an instruction to the second portable device 30 to open a related file when one of the predetermined conditions is satisfied.

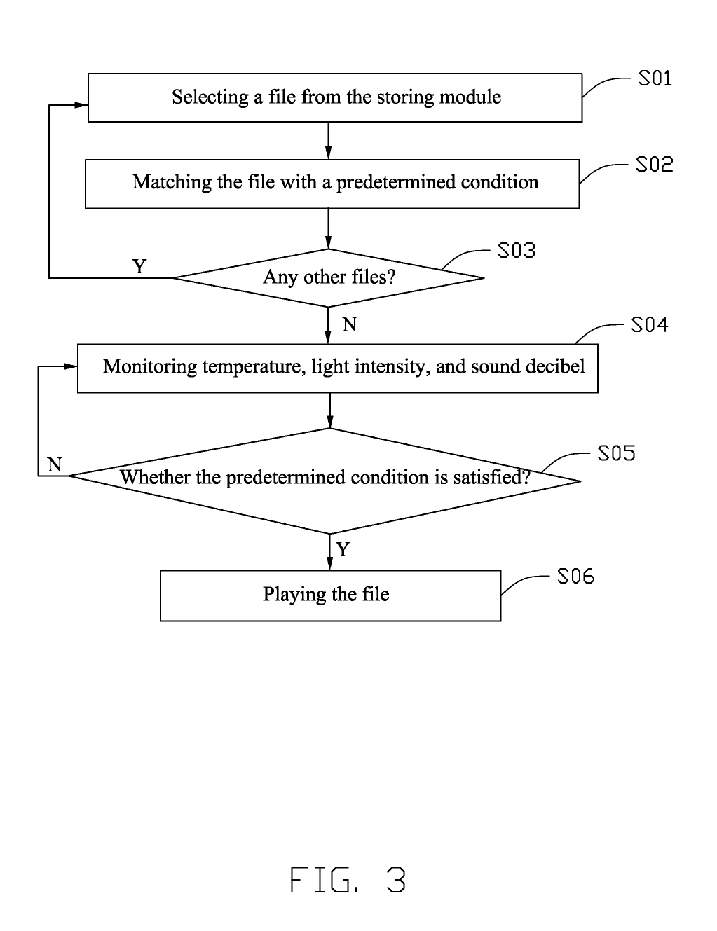

Referring to FIG. 1 and FIG. 3, a flowchart illustrates a method utilizing the above described first embodiment of the system for automatically opening files according to predetermined conditions.

In block S01, a file stored in the storing module 18 of the first portable device 10 is selected. In block S02, the file is matched with a predetermined condition when the setting module 12 of the first portable device 10 is enabled. In block S03, if there is another file need to be matched with another predetermined condition, go back to block S01; if not, go to block S04. In block S04, the processing module 14 of the first portable device 10 monitors ambient temperature, light intensity, and sound level detected by the temperature sensor 11, the light sensor 13, and the sound sensor 15. In block S05, if the predetermined condition is satisfied, go to block S06; if not, go back to block S04. In block S06, the executing module 16 of the first portable device 10 plays the file, such as playing a file of former birthday photos during the user's birthday, or playing a gentle and slow song when the light intensity and the sound intensity are both at a low level.

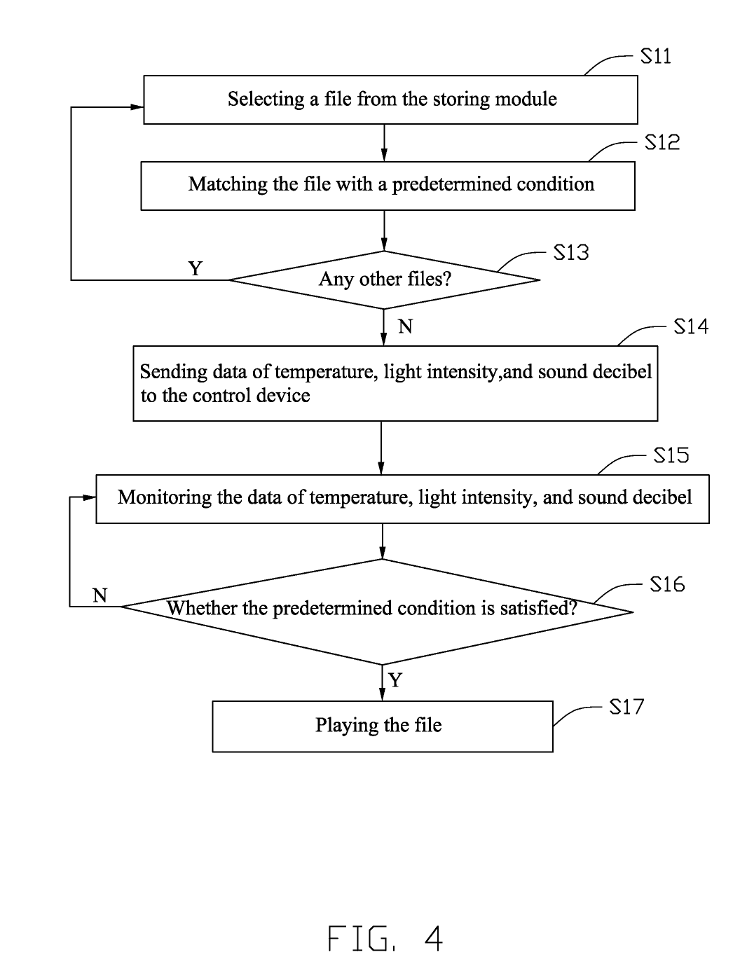

Referring to FIG. 2 and FIG. 4, a flowchart illustrates a method utilizing the above described second embodiment of the system of for automatically opening files associated with predetermined conditions.

In block S11, a file stored in the first or second storing module 26, 34 of the control device 20 or the second portable device 30 is selected. In block S12, the file is matched with a predetermined condition when the setting module 22 of the control device 20 is enabled. In block S13, if there is another file need to be matched with another predetermined condition, go back to block S11; if not, go to block S14. In block S14, the second portable device 30 sends data of ambient temperature, light intensity, and sound level detected by the temperature sensor 31, the light sensor 33, and the sound sensor 35 to the control device 20. In block S15, the processing module 24 of the control device 20 monitors the data of temperature, light intensity, and sound level. In block S16, if the predetermined condition is satisfied, go to block S17; if not, go back to block S15. In block S17, the executing module 32 of the second portable device 20 plays the file.

In the embodiments, the predetermined condition includes a predetermined time period, and/or a predetermined range of temperature, and/or a predetermined range of light intensity, and/or a predetermined decibel range of sound level. The step of monitoring (step S04 or S15) includes comparing the detected temperature with the predetermined range of temperature, comparing the detected light intensity with the predetermined range of light intensity, and comparing the sound level with the predetermined decibel range. When the time period comes, and/or the detected temperature, and/or the detected light intensity, and/or the detected sound level is/are in the predetermined range(s), a related file is opened, such as displaying a related photo, or playing a related song.

Depending on the first or second embodiment of the method described above, certain of the blocks may be removed, others may be added, and the sequence of blocks may be altered.

It is to be understood, however, that even though numerous characteristics and advantages of the present embodiments have been set forth in the foregoing description, together with details of the structure and function of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. A system comprising:
an executing module capable of opening files;
a setting module utilized for matching each of the files with a predetermined condition;
at least a sensor capable of sensing environmental condition relating to the predetermined condition; and
a processing module capable of monitoring the environment information to determine whether the predetermined condition is satisfied and sending an instruction to the executing module to open a related file when the predetermined condition is satisfied.

2. The system of claim 1, wherein the sensor is a temperature sensor capable of detecting environment temperature and sending the temperature data to the processing module.

3. The system of claim 1, wherein the sensor is a light sensor capable of detecting environment light intensity and sending the light intensity data to the processing module.

4. The system of claim 1, wherein the sensor is a sound sensor capable of detecting sound intensity and sending the sound intensity data to the processing module.

5. The system of claim 1, wherein the executing module, the setting module, the sensor, and the processing module are installed in a portable device.

6. The system of claim 1, wherein the executing module and the sensor are installed in a portable device, and the setting module and the processing module are installed in a control device.

7. The system of claim 6, wherein the portable device is selected from a digital photo frame, a MP3/MP4/MP5 player, and a cell phone, and the control device is a computer.

8. A method for automatically opening a file associated with a predetermined condition, the method comprising:
matching the file with the predetermined condition;
sensing environmental information;
sending data of the environmental information to a processing module;
monitoring the data of the environmental information to determine whether the predetermined condition is satisfied; and
sending an instruction to an executing module to open the file if the predetermined condition is satisfied.

9. The method of claim 8, wherein the predetermined condition comprises a predetermined time period, and/or a predetermined range of temperature, and/or a predetermined range of light intensity, and/or a predetermined range of sound intensity.

10. The method of claim 9, wherein the monitoring step comprising comparing the detected temperature with the predetermined range of temperature, comparing the detected light intensity with the predetermined range of light intensity, and comparing the detected sound intensity with the predetermined range of sound intensity.

11. The method of claim 8, further comprising selecting the file from a storing module of a portable device before the matching step.

12. The method of claim 8, further comprising connecting a portable device to a control device, wherein the processing module is installed in the control device, and the executing module is installed in the portable device.
